(19) United States
(12) Patent Application Publication
(10) Pub. No.: US 2024/0225316 A1
(43) Pub. Date: Jul. 11, 2024

(54) SYSTEM AND METHOD FOR AUTOMATED CHECKOUT

(71) Applicants: Vivek Malik, San Carlos, CA (US); Motilal Agrawal, San Carlos, CA (US); Krishna Motukuri, San Carlos, CA (US)

(72) Inventors: Vivek Malik, San Carlos, CA (US); Motilal Agrawal, San Carlos, CA (US); Krishna Motukuri, San Carlos, CA (US)

(21) Appl. No.: 18/562,753

(22) PCT Filed: May 20, 2022
(86) PCT No.: PCT/US2022/030307

§ 371 Date: Nov. 20, 2023

Related U.S. Application Data
(60) Provisional application No. 63/190,878, filed on May 20, 2021.

(51) Int. Cl. A47F 10/02; H04L 12/10

(52) U.S. Cl. CPC A47F 10/02; H04L 12/10; A47F 2010/025

(57) ABSTRACT

A shelf comprising a sensing assembly and a base assembly, further wherein: the sensing assembly comprises a plurality of lanes, each of the plurality of lanes comprising at least one sensing plate coupled to a plurality of load cells, the plurality of load cells coupled to the at least one sensing plate and the base assembly, and the plurality of load cells located within a measurement section.

### CROSS-REFERENCE TO RELATED APPLICATION

This application claims priority to U.S. Provisional Patent Application No. 63/190,878 filed on May 20, 2021, which is hereby incorporated by reference herein in its entirety.

### FIELD OF THE INVENTION

The present disclosure relates to automated checkout technology, and in particular smart shelving for automated checkout technology.

### BRIEF SUMMARY

A shelf comprising a sensing assembly and a base assembly, further wherein: the sensing assembly comprises a plurality of lanes, each of the plurality of lanes comprising at least one sensing plate coupled to a plurality of load cells, the plurality of load cells coupled to the at least one sensing plate and the base assembly, and the plurality of load cells located within a measurement section.

A method to assemble a shelf for a smart shelving subsystem, comprising: coupling a sensing assembly to a base assembly using a plurality of load cells comprising a first and a second set of load cell receiving members, the coupling comprising coupling a first set of load cell receiving members to the base assembly, electrically and communicatively coupling the load cells to a shelf electronic unit, and coupling a second set of load cell receiving members to a measurement section of a sensing plate in the sensing assembly; creating one or more lanes on the top surface of the sensing assembly; placing the assembled shelf on a space in a gondola; and electrically and communicatively coupling the shelf to a shelf controller.

A system to support an angled shelf comprising a first and a second support member, wherein each of the first and second support member comprise a support arm, a wire management subsystem, a group of load cells, and a top member; wherein a first load cell from the group of load cells comprises a first set of load cell coupling members to couple the first load cell to the support arm, and a second set of load cell coupling members to couple the first load cell to the top member.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates an example embodiment of a smart shelving system.

FIG. 2 illustrates an example of a shelf for a smart shelving system.

FIG. 3A shows an example embodiment of sensing assembly.

FIG. 3B illustrates an example embodiment of a sensing plate.

FIG. 3C illustrates coupling of a sensing plate to a plurality of load cells.

FIG. 3D illustrates the location of a measurement section on a sensing plate.

FIG. 3E illustrates the flexing when an object is placed on the top surface of a sensing plate.

FIG. 3F shows an example embodiment of a sensing plate with airflow openings.

FIG. 4A shows an example embodiment of lanes being created on the top surface of a sensing assembly.

FIG. 4B shows an example embodiment of a lane.

FIG. 4C shows an example embodiment of a handrail.

FIG. 4D shows an example embodiment of one or more lane partition fastening members and one or more lane partition connecting members.

FIG. 4E shows an example embodiment of a spacer element.

FIG. 5A shows an example embodiment of transverse edges for a gravity fed configuration.

FIG. 5B shows an example embodiment where a lane partition fastening member attaches to a lane partition connection member in a raised section at a transverse edge of a sensing plate.

FIG. 6A illustrates an example embodiment of a base assembly.

FIG. 6B illustrates an example embodiment of RJ-45 ports to receive power and data.

FIG. 6C illustrates an example embodiment of holding members for the base assembly.

FIG. 7 illustrates an example embodiment of coupling a sensing assembly to a base assembly via load cells.

FIG. 8A illustrates an example embodiment of electrical and communication subsystems within a shelf.

FIG. 8B illustrates the electrical and communication connections from a shelf controller to a shelf and various other components in a retail outlet.

FIG. 8C illustrates an example embodiment of a process to assemble a shelf.

FIG. 9A illustrates an example embodiment of two support members.

FIG. 9B illustrates an example embodiment of a left and a right support member.

FIG. 9C illustrates an example embodiment of a left support arm.

FIG. 9D illustrates an example embodiment of a right support arm.

FIG. 9E illustrates an example embodiment of a wire management subsystem.

FIG. 9F illustrates groups of load cells being attached to the left and the right support arms.

FIG. 9G shows an example embodiment of a left top member.

FIG. 9H shows an example embodiment of a right top member.

FIG. 10 shows an example flowchart for assembly of an angled shelf.

FIG. 11 illustrates an example embodiment of a management system.

FIG. 12 illustrates an example embodiment of a process flow when a customer takes an item from a shelf.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many retailers are contemplating installing automated checkout systems so as to reduce cost of maintaining brick and mortar outlets. These automated checkout systems comprise, for example, camera or other video capture subsystems to capture video and determine which items have been taken by customers, so as to be able to bill the customers.

However, these video capture subsystems have shortcomings. For example, a first camera which is part of a video capture subsystem installed in a retail outlet captures video from a first zone, and a second camera which is also part of the video capture subsystem captures video from a second zone adjacent to the first zone. The first and the second zone are usually designed to overlap with each other. Therefore, when a customer moves from the first zone to the second zone, the video capture subsystem does not lose track of the customer.

In spite of this, video capture subsystems on their own may not suffice for operation of an automated checkout system. This may be due to the obscuring of camera viewing fields by walls and other objects.

To overcome these shortcomings, smart shelving subsystems are employed in conjunction with video capture subsystems for billing of customers. These smart shelving subsystems detect what a customer has picked up from a shelf, and is able to calculate and determine what the customer should pay.

An example of a smart shelving subsystem is given in US Patent Application Publication No. 2013/0284806 to Margalit et al, filed on Oct. 19, 2012 and published on Oct. 31, 2013. The smart shelving subsystem detailed in US Patent Application Publication No. 2013/0284806 is intended to be used for automated checkout. However, it suffers from some shortcomings. Firstly, the weight sensors in US Patent Application Publication No. 2013/0284806 are located under each corner of a top member of a shelf. When heavy objects are placed on the shelf, the shelf flexes under the weight of the item. The gradient due to flexing is greatest at the corners of the shelf. This may lead to less than ideal measurement of the weights of objects, and therefore lead to errors. Using a thicker material for the shelves may mitigate this problem somewhat. However, using a thicker material increases the weight of the shelves, thus making refilling and repositioning the shelves more difficult. Furthermore, this may also increase the cost of the shelves. US Patent Application Publication No. 2013/0284806 does specify that a single weight sensor can be located at the centre of the top member. While this mitigates the problems due to flexing somewhat, the mitigation is contingent upon the depth of the shelf. If an object is placed away from the centre and closer to the corners, then the flexing may be great enough that there are still weighing instabilities and inaccuracies.

Furthermore, to supply power to the shelf and the control units, each shelf in the system of US Patent Application Publication No. 2013/0284806 needs to be connected to a power outlet to receive power. This leads to increased cabling requirements, more clutter and potentially greater installation cost.

Furthermore, there is a need to improve the utilization of the available shelf space and the retail or Stock Keeping Unit (SKU) density. For example, shelves in many prior use systems are typically around 8 inches (20.32 cm) in width. Since many popular canned drinks utilize cans of diameter 2.54 inches (6.45 cm), only 2 cans placed side by side can occupy the shelf space. This leads to inefficient utilization of the available shelf space and reduces the retail or SKU density, which hurts overall sales of the retail location.

A system and method for smart shelving which overcomes the issues due to systems such as the one detailed in US Patent Application Publication No. 2013/0284806 is described below.

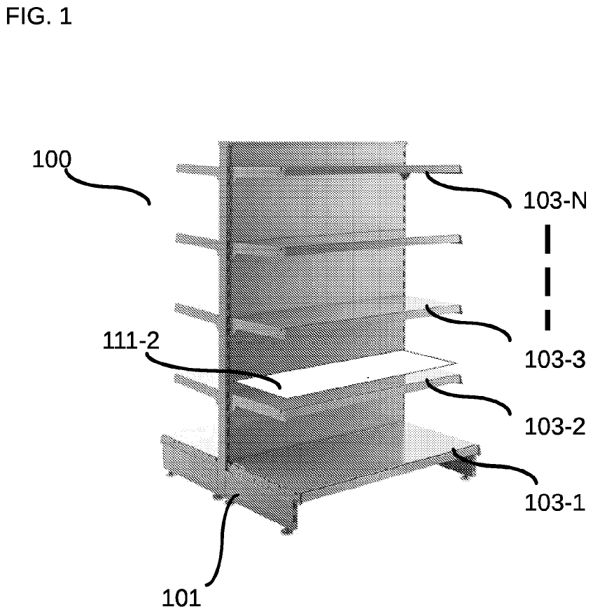

FIG. 1 shows an example of such a smart shelving system. A smart shelving system 100 for a gondola 101 having spaces 103-1 to 103-N for one or more shelves is shown in FIG. 1. For example, as shown in FIG. 1, space 103-2 is used for shelf 111-2.

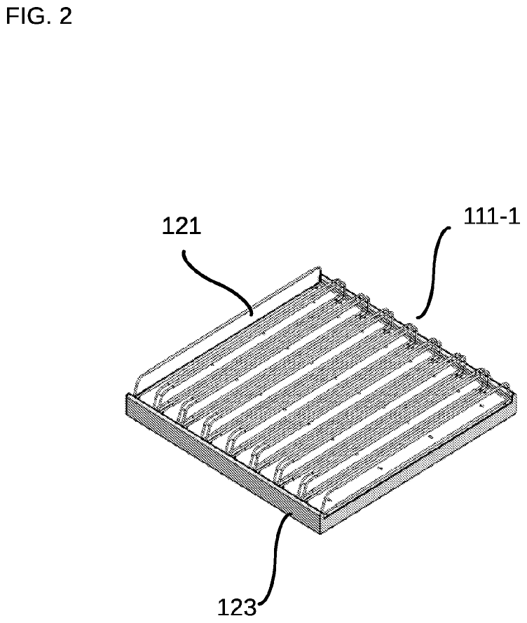

FIG. 2 shows an example shelf 111-1. Shelf 111-1 comprises a sensing assembly 121 coupled to a base assembly 123.

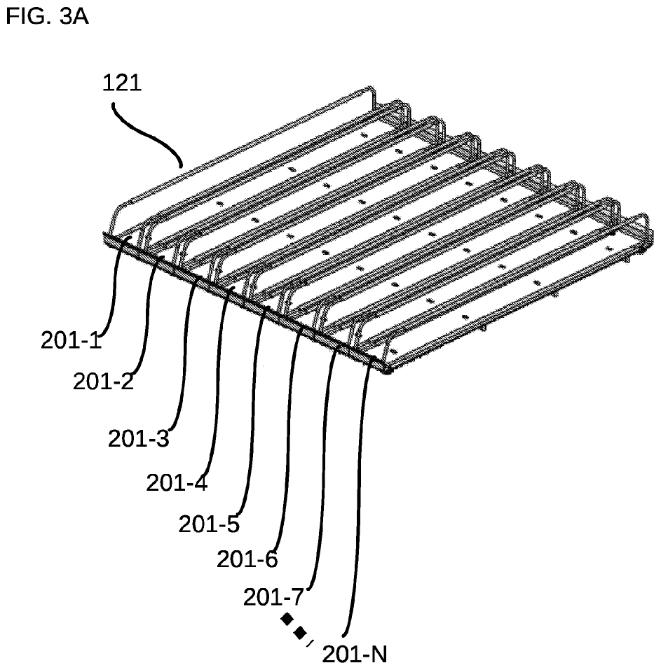

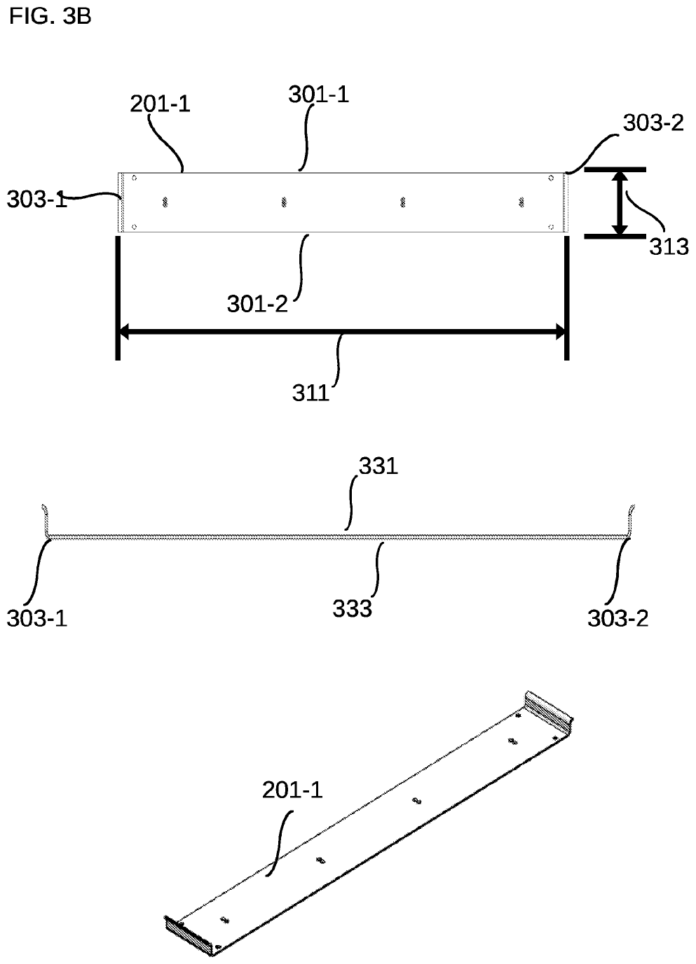

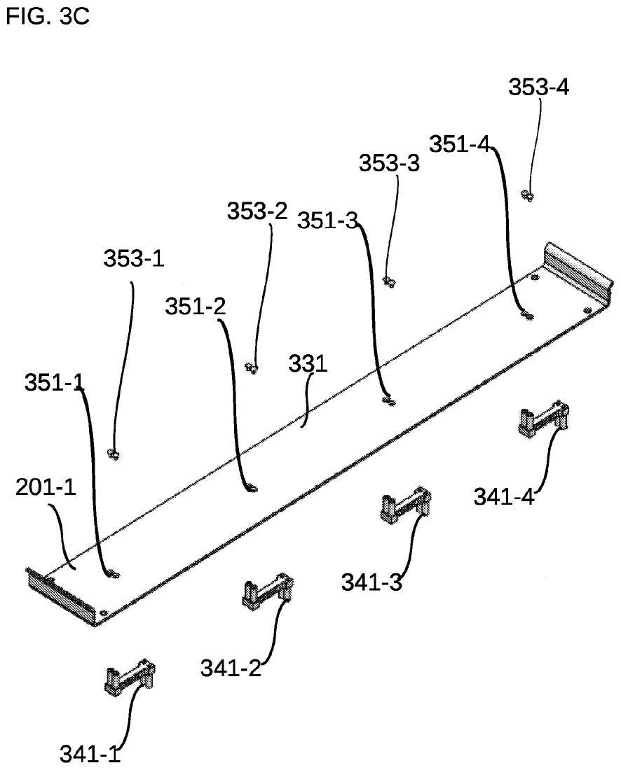

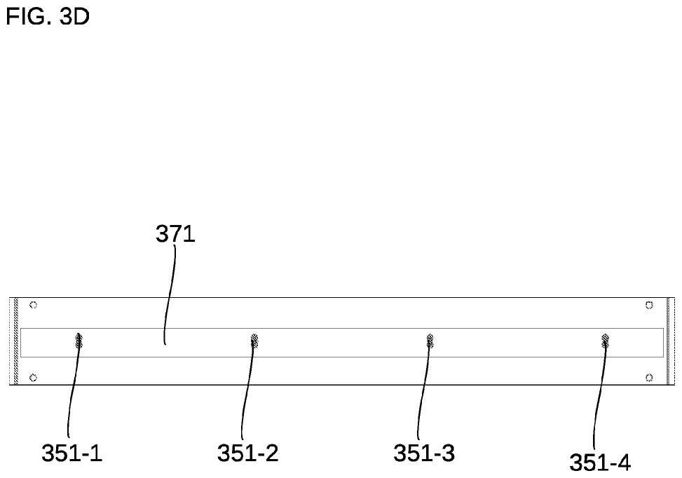

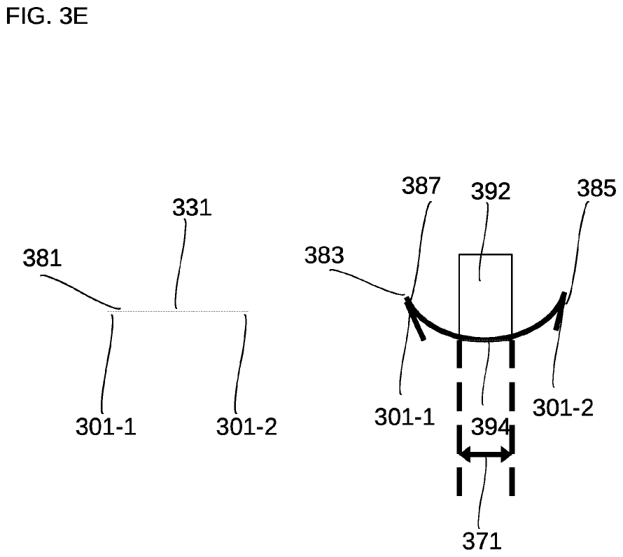

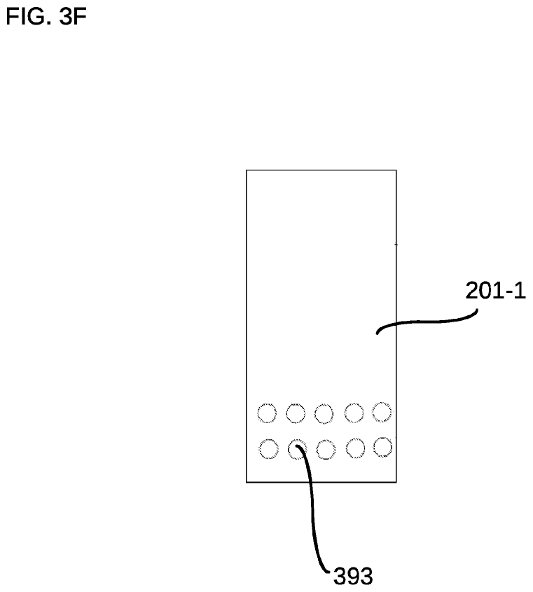

FIG. 3A shows an example embodiment of sensing assembly 121. In FIG. 3A, sensing assembly 121 comprises sensing plates 201-1 to 201-N.

FIG. 3B shows top, side and isometric views of an example embodiment of sensing plate 201-1. In some embodiments, the sensing plate is rectangular and comprises, for example, two longitudinal edges opposed to each other, and two transverse edges opposed to each other. For example, as shown in FIG. 3B, sensing plate 201-1 is rectangular with longitudinal edges 301-1 and 301-2, and transverse edges 303-1 and 303-2. The longitudinal edges have length 311 and the transverse edges have width 313. Sensing plate 201-1 has a top surface 331 and a bottom surface 333. Items or objects for sale are placed on the top surface 331 of the sensing plate 201-1. In some embodiments, the top surface 331 of the sensing plate 201-1 is substantially smooth.

Each of sensing plates 201-1 to 201-N is associated with a plurality of weight sensors or load cells. For example, as shown in FIG. 3C, sensing plate 201-1 is associated with plurality of weight sensors or load cells 341-1 to 341-4.

In some embodiments, each of the sensing plates 201-1 to 201-N is coupled to a plurality of load cells. This coupling can be achieved in a variety of ways. For example, as shown in FIG. 3C, sensing plate 201-1 is coupled to a plurality of load cells 341-1 to 341-4. The sensing plate comprises one or more load cell coupling members to enable this coupling to take place. For example, as shown in FIG. 3C, the sensing plate 201-1 comprises load cell coupling members 351-1 to 351-4 in the form of openings extending from the top surface 331 to the bottom surface 333. Then, load cell fastening members are used together with the load cell coupling members to couple the load cells at that location on the sensing plate. For example, with reference to the embodiment shown in FIG. 3C, the load cell fastening members are fasteners 353-1 to 353-4. These are inserted into the openings 351-1 to 351-4 to enable coupling of the load cells at the locations of the openings. In some embodiments, the load cell fastening members are low profile fasteners which have heads flush with the top surface 331 when inserted fully into openings 351-1 to 351-4. These low profile fasteners are then attached to the load cells, as will be explained further below.

In some embodiments, the load cell coupling members are located within a measurement section on the sensing plate, so that the load cells can also be located within the measurement section. For example, as shown in FIG. 3D, load cell coupling members 351-1 to 351-4 are located within measurement section 371 of sensing plate 201-1.

In some embodiments, the location of the measurement section is based on the flexing when an object is placed on the top surface of the sensing plate. For example, as shown in FIG. 3E, before an object is placed on the top surface, the sensing plate 201-1 is in unflexed condition 381. After object 392 is placed on the top surface, the sensing plate goes into a flexed condition 383. As can be seen in FIG. 3E, the gradients 385 and 387 at the edges 301-1 and 301-2 of the flexed sensing plate tends to be greater as compared to gradient 394 which is closer to the centre. If a load cell is placed in a region where the gradient of the flexed sensing plate is too great, then there may be inaccuracies. For example, if a load cell is placed at an edge 301-1 or 301-2, or in a corner where the gradient is highest, then there may be inaccuracies. This is a problem which may occur, if the plurality of load cells are placed in the corners or close to the edges as explained in the system of US Patent Application Publication No. 2013/0284806. Placing one of the plurality of load cells in the geometric center, as explained in US Patent Application Publication No. 2013/0284806, may mitigate this problem. However the results are not as accurate as compared to placing the plurality of the load cells within the measurement section such as section 371 of FIG. 3E.

Then, the measurement section is the region of the sensing plate where the gradient is sufficiently small such that reported weights are likely to be more accurate. In some embodiments, the measurement section is determined by comparison of the gradient to a threshold. For example, with reference to FIG. 3E, the measurement section is set to be region 371 since the gradient 391 within that region is relatively small. The location of the measurement section can be determined in a variety of ways including, for example, calculation, testing and measurement and simulation. Placing the load cells within the measurement section allows for greater width and length of the sensing plate, as compared to placing the load cells at the corners with or without one load cell in the centre of the sensing plate. Greater width and length of the sensing plate allows for a higher density of items to be placed on the shelf. In one embodiment, the width of the sensing plate is 3 inches (7.62 cm), which is sufficient to accommodate a can of diameter 2.54 inches (6.45 cm). Using this width leads to more efficient utilization of the available shelving space for canned drinks, unlike prior use systems as discussed above. In further embodiments, shelves have between 8 and 16 sensing plates, leading to a shelf that is between 24 and 48 inches (60.96 and 121.92 cm) in width. In some embodiments, the length 311 of the sensing plate is around 13 inches (33.02 cm).

In some embodiments, airflow openings are made in the sensing plate for the cases where the sensing plate is to be used in temperature controlled environments such as refrigerators and freezers. This ensures sufficient airflow to maintain consistent cooling throughout. An example embodiment is shown in FIG. 3F, where sensing plate 201-1 has airflow openings 393.

Various types of load cells can be used, depending on the environment. For example, in a situation where the shelf is employed in a high temperature environment, high temperature load cells should be used. The load cells can be, for example, half bridge or full bridge load cells.

In some embodiments, one or more lanes are formed on the top surface of the sensing assembly. Each lane has a width corresponding to the number of sensing plates included within the lane. Then, items for sale are placed within each lane. Each lane is bounded by lane partition members, which serve to keep the items within their respective lanes.

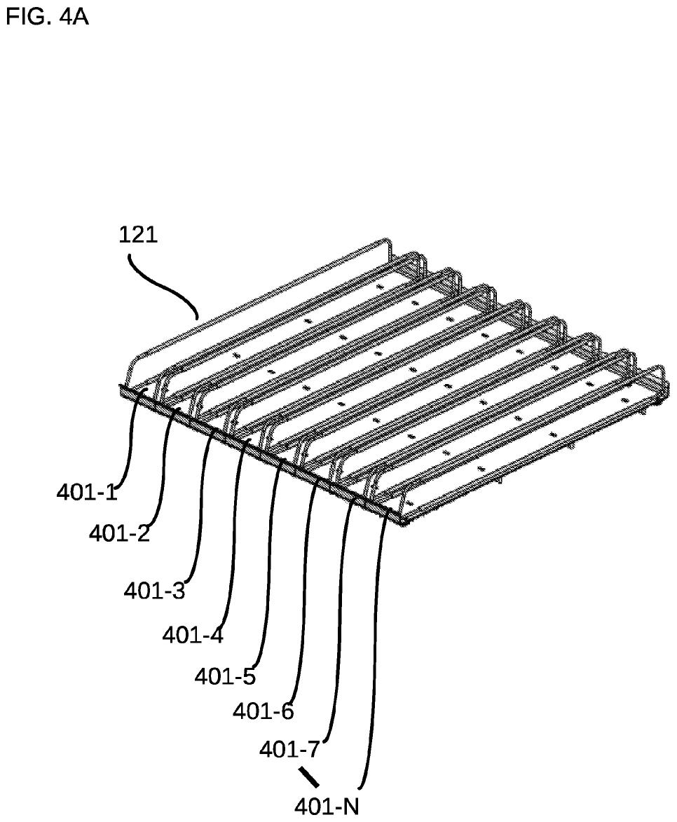

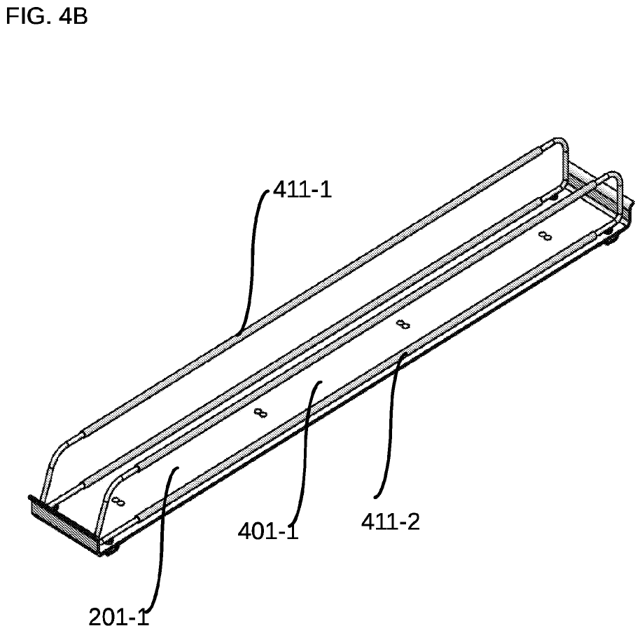

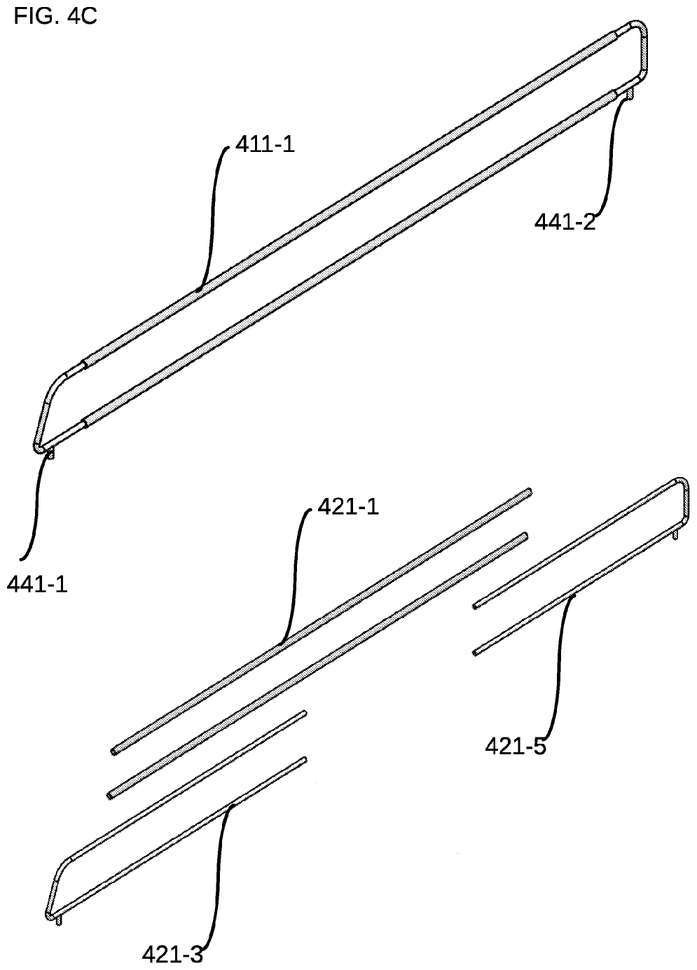

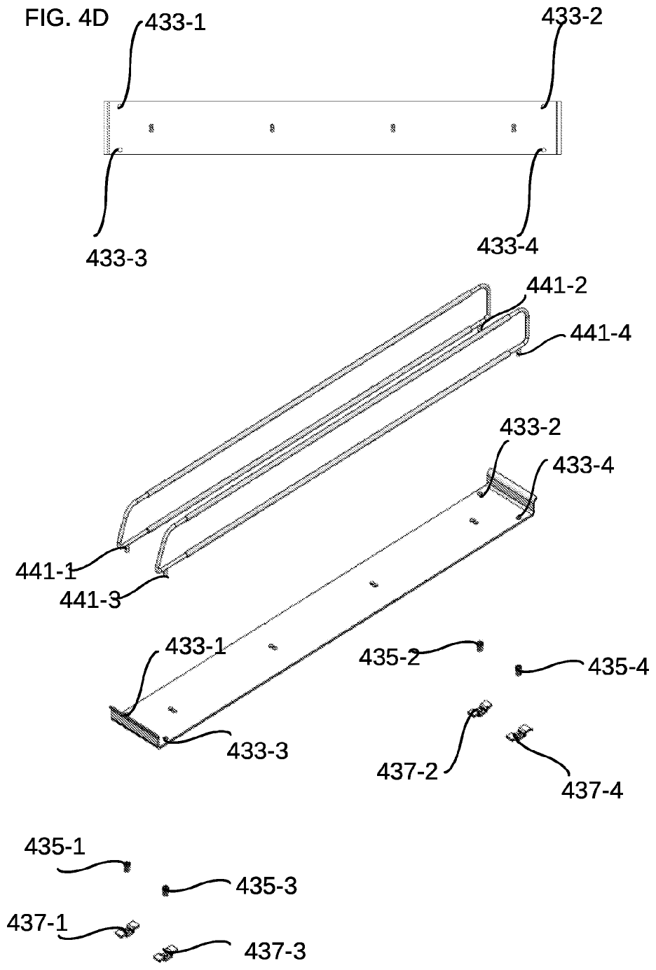

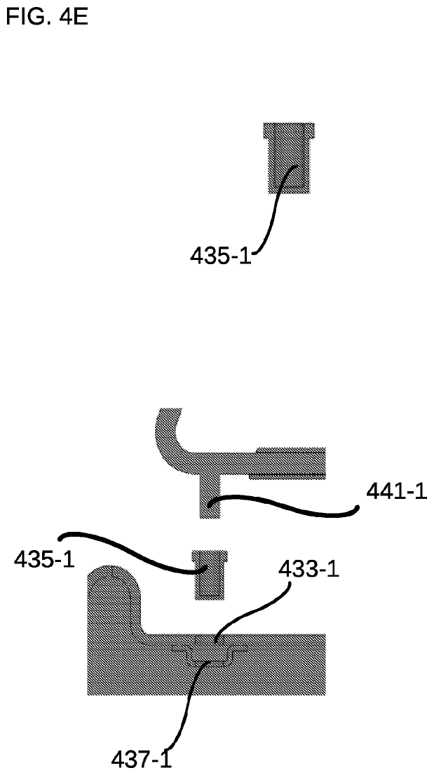

An example embodiment is shown in FIG. 4A. In FIG. 4A, lanes 401-1 to 401-N are created on the top surface of sensing assembly 121. For the example embodiment shown in FIG. 4A, each lane has a width of one sensing plate as one sensing plate is included within each lane. However, as explained previously, the lane can have a width of more than one sensing plate. For example: While an individual sensing plate has a width of 3 inches (7.62 cm), so as. to accommodate larger objects such as wine bottles having a diameter of 3.5 inches (8.89 cm), the lane width is set to two (2) sensing plates, This can be achieved by placing the lane partition members appropriately, so that the lane has two (2) sensing plates width.

A detailed embodiment of lane 401-1 is shown in FIG. 4B. In FIG. 4B, lane 401-1 includes sensing plate 201-1, and the lane is bounded by two lane partition members in the form of handrails 411-1 and 411-2.

FIG. 4C shows an example embodiment of handrail 411-1. In FIG. 4C, the handrail 411-1 comprises a grip 421-1 attached to a left hand side 421-3 and a right hand side 421-5. Handrail 411-1 also comprises fasteners 441-1 and 441-2, the use of which will be explained later.

Each lane partition member attaches to its corresponding boundary through a combination of one or more lane partition fastening members and one or more lane partition connection members on the outermost sensing plate in the lane. An example embodiment of one or more lane partition fastening members and one or more lane partition connection members is shown in FIG. 4D. In FIG. 4D, the lane partition connection members are formed by openings 433-1 to 433-4; spacer elements 435-1 to 435-4; and flanges 437-1 to 437-4. An example embodiment of lane partition fastening members are fasteners 441-1 to 441-4.

FIG. 4E shows a detailed illustration of a spacer element 435-1. In FIG. 4E the spacer element 435-1 is a plastic ring with an opening for insertion of the fastener and with separation lip. This acts to hold the handrail in place vertically, and also the separation lip acts as a spacer between the bottom of the handrail and the top surface of the sensing plate.

An example of a lane partition member attaching to its boundary is shown in FIG. 4E. In FIG. 4E, the flange 437-1 has an opening which extends through its body and is attached to the bottom surface of the sensing assembly. In some embodiments, the flange 437-1 is welded to the bottom surface of the sensing assembly. Then, spacer element 435-1 is inserted into opening 433-1 and flange 437-1. Finally, fastener 441-1 is inserted into the opening in spacer element 435-1. The process is repeated for all of the other fasteners, flanges, spacer elements and openings.

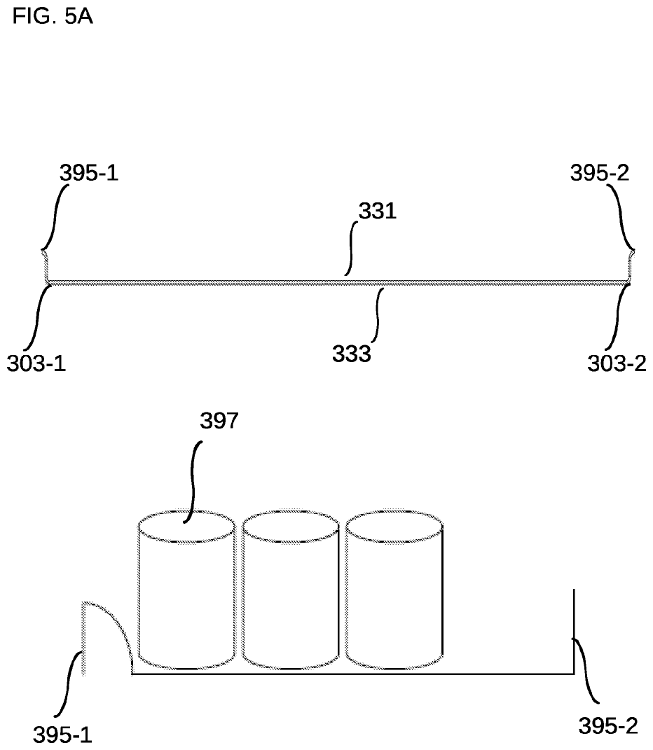

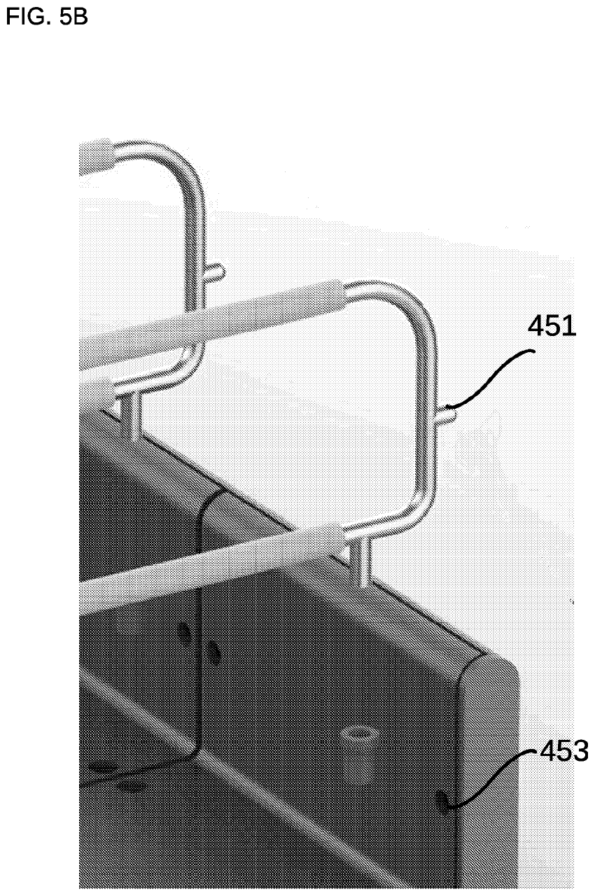

In some embodiments, the shelves are inclined so that when a customer takes a product from the front of a shelf, the products behind slide to the front of the shelf. This is referred to by those of skill in the art as a “gravity-fed” shelf. Then, the transverse edges comprise raised sections to as to stop products placed on the shelf from falling off. An example embodiment is shown in FIG. 5A. Transverse edges 303-1 and 303-2 comprise raised sections 395-1 and 395-2. Then an object such as object 397 is less likely to fall off when placed on top surface 331 and when placed in a gravity-fed configuration. These are commonly used in, for example, refrigerators in stores. In some embodiments, the raised sections 395-1 and 395-2 are the same height. In other embodiments, raised sections 395-1 and 395-2 are unequal in height. In some of these embodiments, raised section 395-2 is higher than section 395-1 to enable insertion of lane partition connection members in the form of openings, as will be explained next.

In other embodiments, the lane partition fastening members comprise fastening members to attach to the raised section located at the transverse edge of the sensing plate, at locations adjacent to the boundary. In these embodiments, the lane partition connection members comprise openings in the raised section at the transverse edge of the sensing plate, also located at the boundary. An example is shown in FIG. 5B. Lane partition fastening member 451 attaches to opening 453 in the raised section at the transverse edge of the sensing plate.

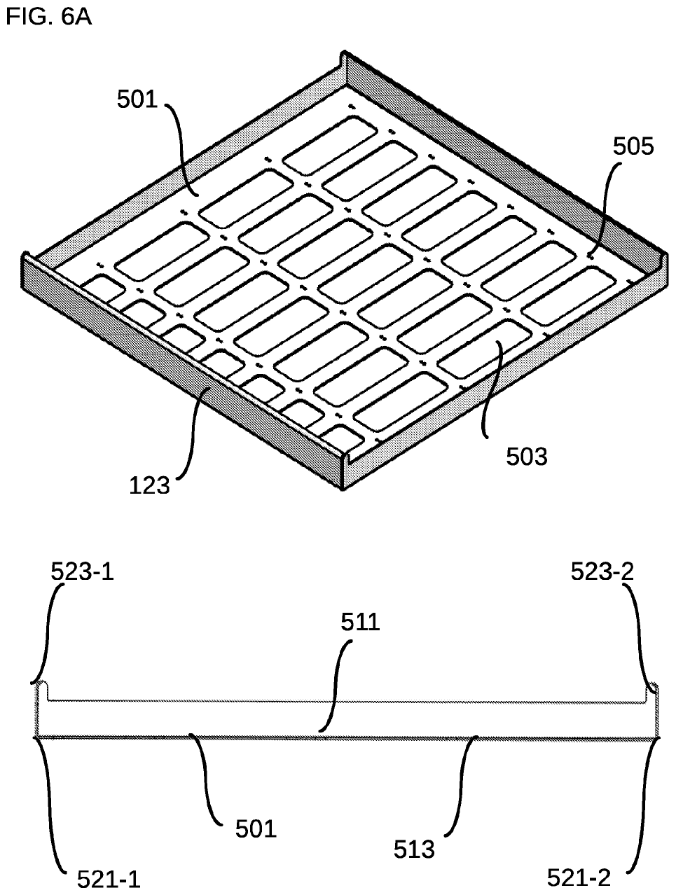

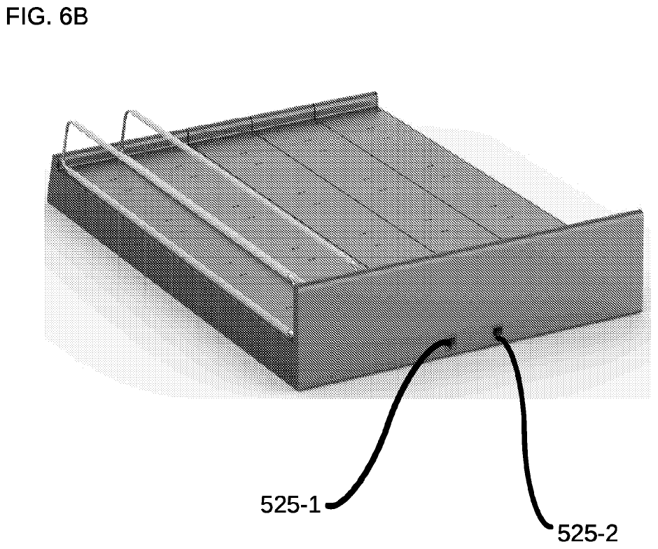

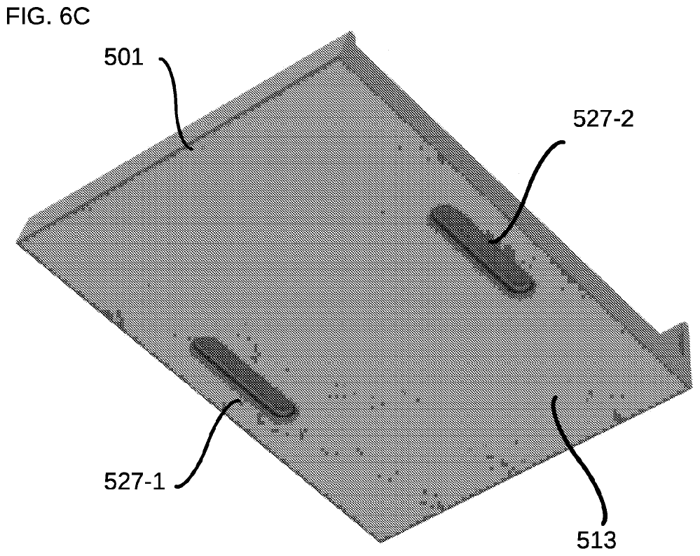

The base assembly 123 of FIG. 2 will now be described. FIG. 6A shows isometric and side views of base assembly 123. The base assembly 123 comprises a base plate 501. In some embodiments, the base plate is solid. In other embodiments, the base plate has openings such as openings 503 so as to reduce the weight of the base plate and the overall weight of the shelf. In yet other embodiments, the base plate has a top surface 511 and a bottom surface 513. In some embodiments, the bottom surface 513 is rough, to enable adherence to a space of the gondola, such as spaces 103-1 to 103-N as shown in FIG. 1. In further embodiments, the base comprises load cell coupling members such as load cell coupling member 505, to enable coupling of load cells as will be described further below.

In some embodiments, the base plate has transverse edges with transverse receiving members to accommodate the raised sections of the sensing plate. For example, in FIG. 6A, base plate has transverse edges 521-1 and 521-2 with transverse receiving members 523-1 and 523-2 to accommodate raised sections such as sections 395-1 and 395-2 on sensing plate 201-1. In another embodiment, the base plate comprises two Registered Jack-45 (RJ-45) ports to receive power and data. Examples of this are ports 525-1 and 525-2 as shown in FIG. 6B. In yet other embodiments, as shown in FIG. 6C, the base plate has holding members, to enable easier movement of shelves. These holding members are, for example, indented hand holds 527-1 and 527-2 on the bottom surface 513 of base plate 401 as shown in FIG. 6C.

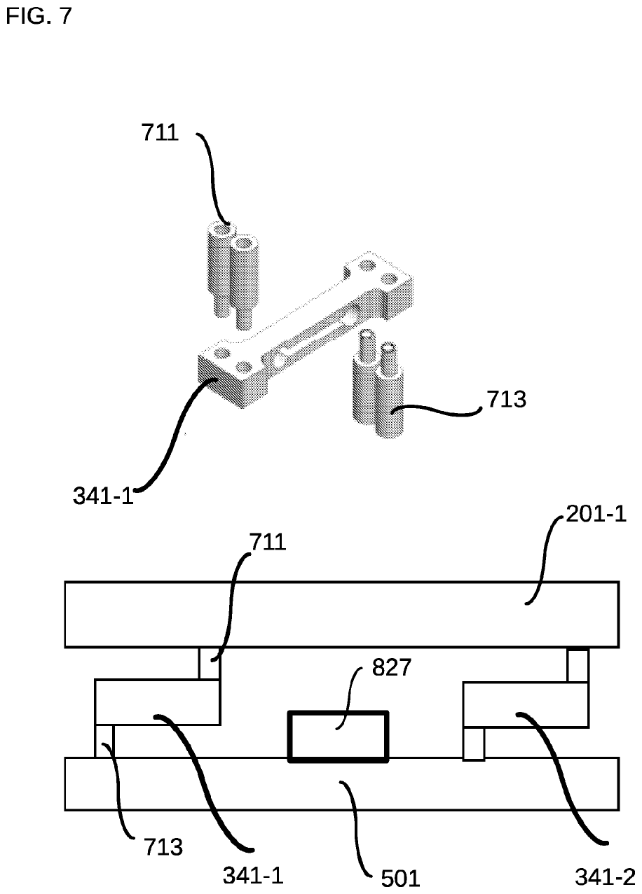

The sensing assembly can be coupled to the base assembly in a variety of ways. In one embodiment, as shown in FIG. 7, the coupling is achieved via the load cells. As explained previously and shown in FIG. 3C, the load cell fastening members 353-1 to 353-4 are inserted into the openings 351-1 to 351-4 respectively. Then, with reference to the detailed diagram of the load cell shown in FIG. 7, each of these load cell fastening members are then received by a first set of load cell receiving members on each of the load cells. For example, load cell fastening members 353-1 is inserted into opening 351-1 and received by set of load cell receiving members 711 in FIG. 7. A similar process takes place to couple the second set of load cell receiving members 713 to the base assembly, except that the load cell fastening members are attached from the bottom surface of the base assembly to the load cell coupling members such as load cell coupling member 505 of FIG. 6A. In some embodiments, the shelf electronics are also attached to the base assembly, as will be described later.

In some embodiments, both the sensing assembly and the base plate are made of metal. Metal has certain advantages over other materials such as plastic. For example, it is easier to configure metallic shelves while installing as compared to plastic.

Other variations are available and known to those of skill in the art. For example, in some embodiments, the shelf will have a light emitting diode (LED) display on the front to display messages, for example, price tags and promotional material such as “Buy One, Get 50% off the 2nd”.

While the above embodiments have been disclosed with regard to an ambient temperature environment, these shelves can also be used in other environments. For example, in some embodiments, these shelves are used in refrigerators and freezers as well. Then, in many jurisdictions, the retail outlet is required to record the temperatures of the refrigerators and freezers for safety reasons and to ensure the best customer experience. Some stores also measure the humidity. Rather than have retail employees walking around manually taking temperature and humidity measurements, in some embodiments, temperature and humidity sensors are used on the shelf. In some embodiments, the temperature and humidity measurements are taken by a combined temperature and humidity sensor. In other embodiments, the temperature and humidity measurements are taken by separate temperature and humidity sensors.

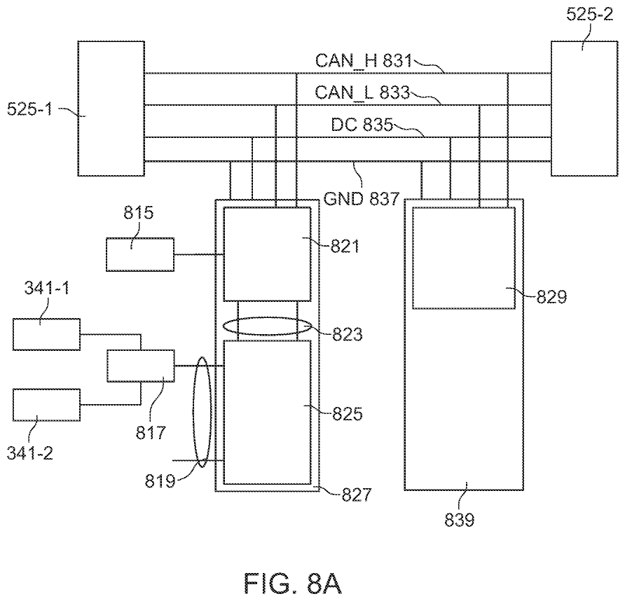

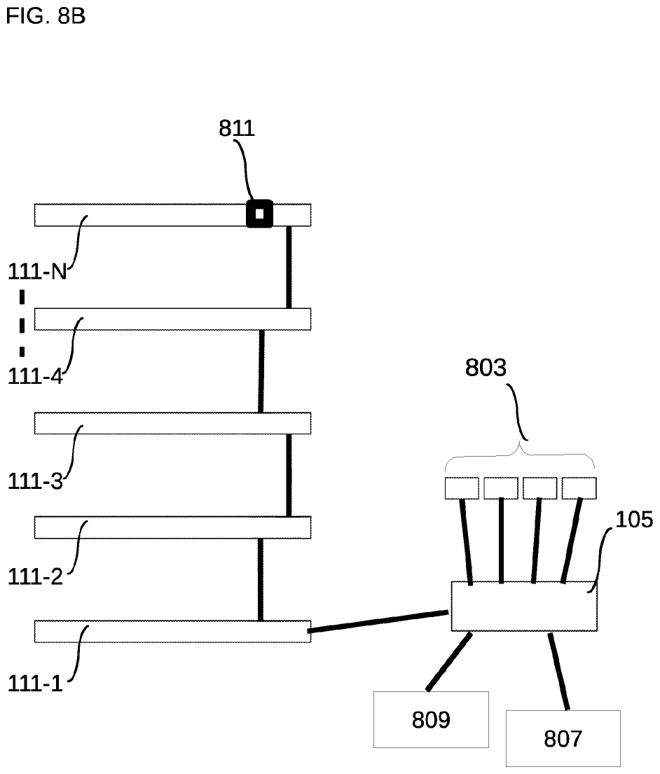

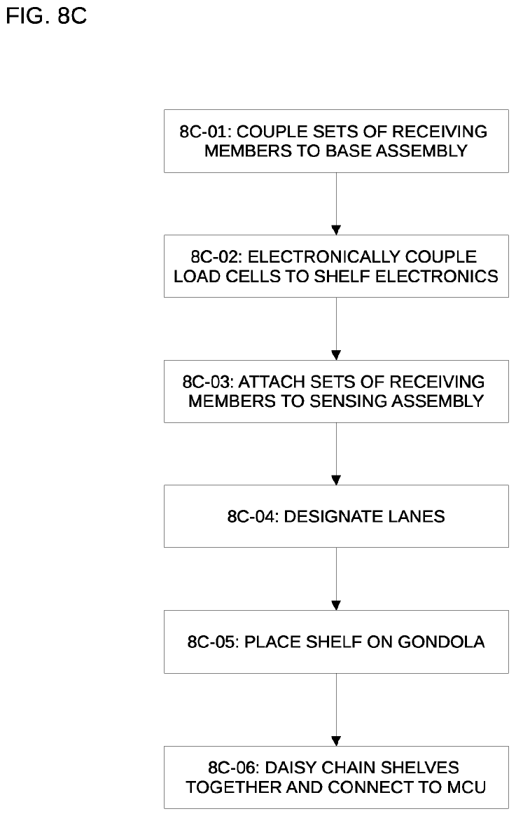

FIG. 8A shows the electrical and communication subsystems within a shelf. Printed circuit board (PCB) 827 and 839 are located on a shelf such as shelf 111-1 of FIG. 2. These PCBs are coupled to buses 831 and 833. Data is transmitted on buses 831 and 833 in accordance with a Collector Area Network (CAN) bus extended frame format. The CAN bus protocol is a multi-master protocol which is well known to those of skill in the art. Buses 831 and 833 correspond to CAN high (CAN_H) and CAN low (CAN_L). PCBs 827 and 839 also receive DC power via connection 835 and ground signal via connection 837 from an RJ-45 cable coupled to jack 525-1. Connections 831, 833, 835 and 837 are also coupled to jack 525-2.

In some embodiments, load cells such as load cells 341-1 and 341-2 are coupled to a summing or other pre-processing board 817 using, for example, wire leads with a pair of 4 pin connectors. The summing or pre-processing board 817 accepts the inputs from the load cells, and processes these multiple inputs into a single lane output for transmission to one or one or more inputs 819 of a multichannel analog-to-digital converter (ADC) 825 residing within PCB 827. By performing analog-to-digital conversion as close as possible to where the signal is generated, noise performance is improved as digitally formatted signals are more noise-resistant compared to analog-formatted signals. The same is repeated for all lanes.

The outputs 823 of the ADC 825 are coupled to multicontroller unit (MCU) 821, which is co-located on PCB 827 with ADC 825. Based on the received digitally formatted signal, the MCU 821 generates signals. This signal generation process comprises the MCU combining the digitally formatted signal from the ADC 825 with a timestamp received from a shelf controller, as will be explained below. The MCU formats the generated signals for transmission using the CAN bus extended frame format. The CAN-formatted generated signals are transmitted by the MCU to CAN-H bus 831 and CAN_L bus 833 for transmission to a shelf controller. While the embodiment shown in FIG. 8A depicts the MCU and the ADC as co-located on a printed circuit board (PCB), one of skill in the art would know that other realizations are also possible.

In some embodiments, the ADC 825 is an 8-channel ADC. Then, each MCU such as MCU 821 can support up to 8 lanes. FIG. 8A shows an embodiment for MCU 821 which resides on PCB 827, and MCU 829 residing on PCB 839. This embodiment shown can then support up to 16 lanes.

As explained previously, there is a need for temperature and humidity sensors to monitor the temperature and humidity of a shelf. FIG. 8A shows an example embodiment where temperature and humidity sensor 815 is coupled to MCU 821. In some embodiments, this coupling is achieved via a 3 pin connector together with a wire lead. In some of these embodiments, the temperature and humidity sensor is located at a suitable distance away from the MCU 821 to reduce thermal noise and error due to the MCU 821. In some embodiments, the temperature and humidity sensors are separate, and are connected to separate three pin connectors on the MCU. In some embodiments, the temperature and humidity measurements are taken using a combined sensor. The MCU generates CAN-formatted signals based on the received temperature and humidity measurements, and transmits the generated CAN-formatted signals via CAN_H and CAN_L buses 831 and 833 to a shelf controller.

FIG. 8B shows the electrical and communication connections from the shelf controller 105 to the shelf and various other components in the retail outlet. In FIG. 8B, shelves 111-1 to 111-N are placed in spaces 103-1 to 103-N of gondola 101. Shelf controller 105 is coupled to the shelves 111-1 to 111-N using an appropriate cable, such as Category 5 enhanced (CAT-5e) or Category 6 (CAT-6) cable. As explained previously and with reference to FIG. 6B, the base assembly on each of the shelves has two RJ-45 ports such as ports 525-1 and 525-2 to receive CAT-5e or CAT-6 cables. The shelf controller delivers power to the shelves 111-1 to 111-N using a passive Power over Ethernet (POE) standard. As will be explained below, interconnections 903 which comprises components such as backroom switch 809 are coupled to the shelf controller 105 using a Power over Ethernet plus (PoE+) standard. In some embodiments, a maximum of 25.5 W of power is supplied to the shelf controller 105 from backroom switch 809. By using the PoE+ standard which utilizes less than a regulatory limit such as 60 W, this obviates the need for a certified electrician in many jurisdictions, thus reducing the cost of installation. In some embodiments, the shelf controller outputs up to 30V and 1.5 A of current, thus supplying around 45 W of power. By using a custom specification where power and data are combined in a single CAT-5e or CAT6 cable, separate cables do not have to be run from each shelf to a power outlet. In one embodiment, the shelves 111-1 to 111-N are connected in series or “daisy-chained” with a termination 811 at the end point as shown in FIG. 8B. In some embodiments, the shelf controller 105 is supplied by power supply 807. In further embodiments, this power supply 807 provides a direct current (DC) voltage of 48V, and a current of less than or equal to 3 A.

In some embodiments, each shelf on the gondola draws about 3.14 W of power. In the embodiments where the shelf controller 105 supplies up to 45 W of power and the per-shelf power consumption is 3.14 W, then the shelf controller 105 can supply a gondola with fourteen (14) shelves. In further embodiments, the shelf controller 105 is Bluetooth and WiFi enabled as well. It is known to those of skill in the art that CAT-5e and CAT 6 cable has four (4) pairs of wires where each pair can support up to 1.5 A of current. In some embodiments, one (1) pair of wires is used for CAN bus data, while three (3) pairs of wires are used for power. This differs from many standard passive PoE implementations where two (2) pairs are used for power.

In some embodiments, as shown in FIG. 8B, the shelf controller 105 is communicatively coupled to one or more reed switches 803 in the doors of refrigerators or freezers. Then, when a door is left open, one of the one or more reed switches 803 transmits a signal to the shelf controller 105, which then transmits alerts to, for example, store operations if the door is left open for too long. This is done to prevent products from going bad or becoming too warm to sell. In some embodiments, the shelf controller 105 sends out a message to the video capture subsystem to run additional models on video feed. This allows the video capture subsystem to focus processing cycles on other parts of the store when the door is closed.

In some embodiments, shelf controller 105 is also communicatively coupled to one or more other sets of shelves 809. In some of these embodiments, shelf controller 105 also supplies power and is communicatively coupled in the same way as with the shelves 111-1 to 111-N. In some embodiments, the shelf controller 105 also broadcasts a timestamp signal to all the MCUs coupled to the shelf controller to ensure that the shelf controller 105 is synced to the MCUs, and that all the MCUs are synchronized to each other.

FIG. 8C shows an example embodiment of a process to assemble a shelf such as shelf 111-1. In steps 8C-01 to 8C-03, the load cells are used to couple the sensing assembly to the base assembly. In step 8C-01, for each load cell, the corresponding set of load cell receiving members is coupled to the base assembly. For example, with reference to FIG. 7A and load cell 341-1, the set of load cell receiving members 713 is coupled to base assembly 501. This involves, for example inserting fastening members into openings formed on base assembly 501 so that load cell receiving members 713 can receive these fastening members.

In step 8C-02, the load cells are electrically and communicatively coupled to the other shelf electronic components. For example, load cell 341-1 is coupled to pre-processing board 817.

In step 8C-03, for each load cell, the corresponding set of load cell receiving members is coupled to the sensing assembly. For example, with reference to FIG. 7A and load cell 341-1, the set of load cell receiving members 711 is coupled to sensing plate 201-1. As explained above and with reference to FIGS. 3C and 7A, this comprises load cell fastening members 353-1 being inserted into opening 351-1 and received by set of load cell receiving members 711 on load cell 341-1.

In step 8C-04, the lanes are designated on the top surface of the sensing assembly, as explained previously with reference to, for example, FIGS. 4A-4E. This comprises, for example:
determining a lane width by determining the number of sensing plates within a lane as explained above; and
attaching lane partition members to corresponding boundaries as explained above.

In step 8C-05, the shelf is placed on a space in a structure such as a gondola. For example, the shelf is placed in one of spaces 103-1 to 103-N on gondola 101 of FIG. 1.

In step 8C-06, the shelves are electrically and communicatively coupled to each other and to a shelf controller and other systems as necessary, as explained above. Further configuration is performed to, for example, enable billing and invoicing when items are taken from lanes by customers.

As explained, in some embodiments the shelves are angled to enable gravity fed configurations. Furthermore, in some environments, it is necessary to leave space under the part of the shelf which carries the food items to accommodate, for example, heating elements. This is useful for keeping the temperature of food items such as chicken above a certain threshold. Then it is necessary to move the load cells away from under the part of the shelf which carries the food items.

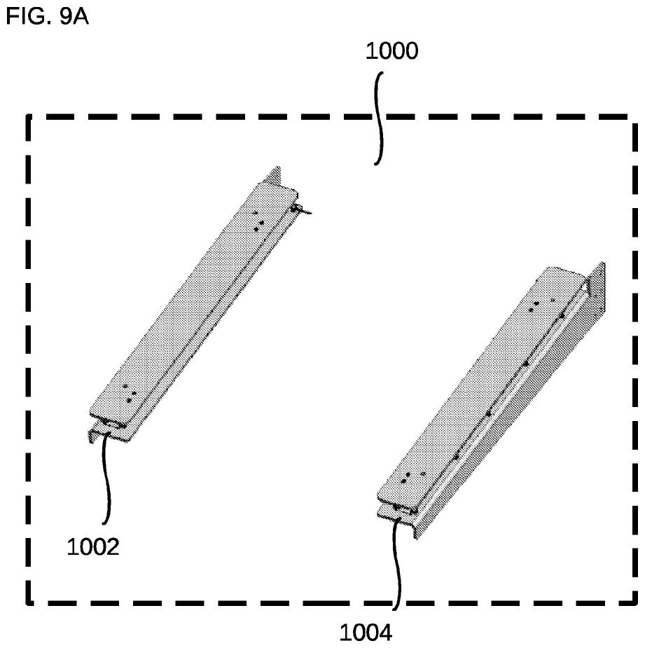

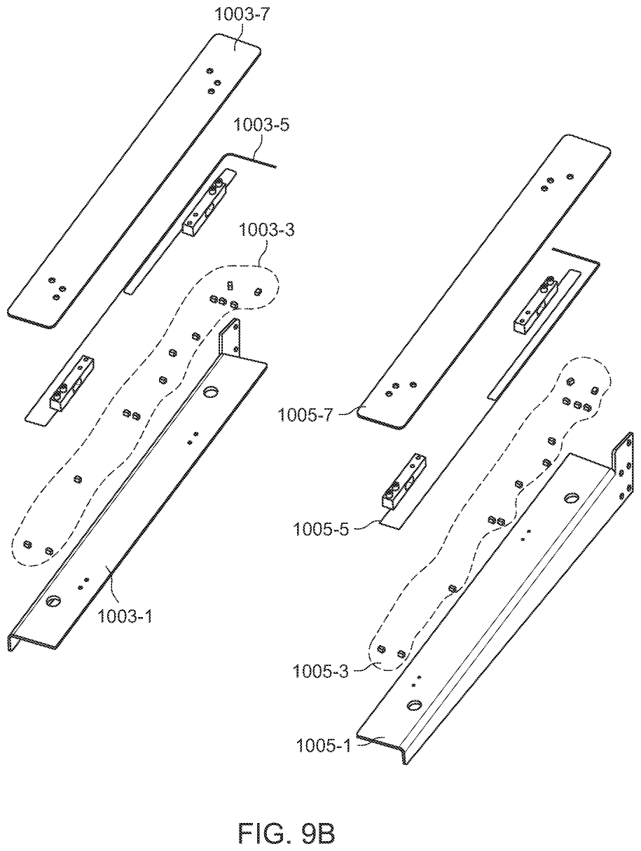

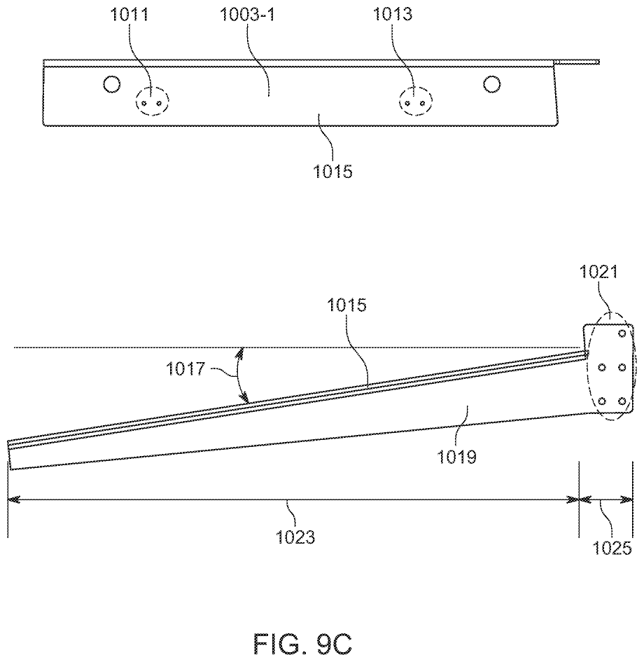

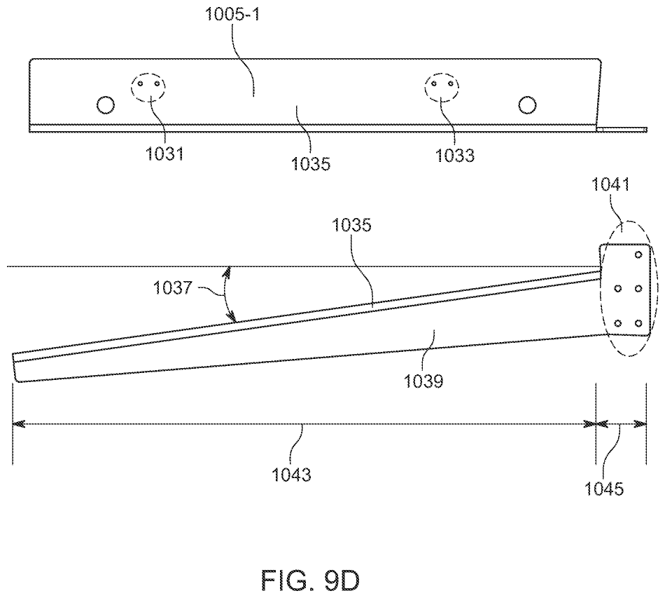

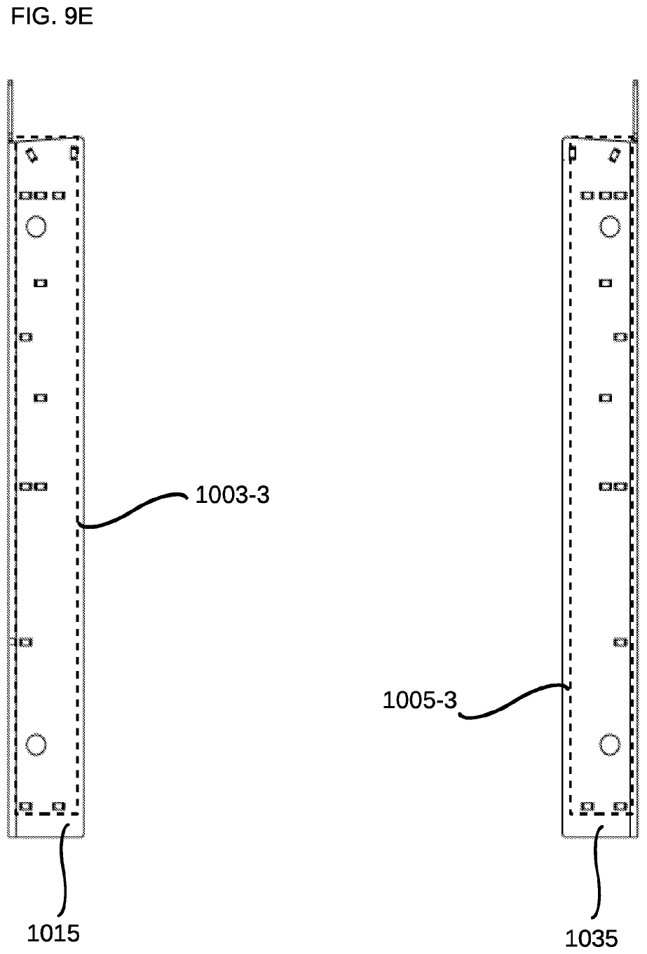

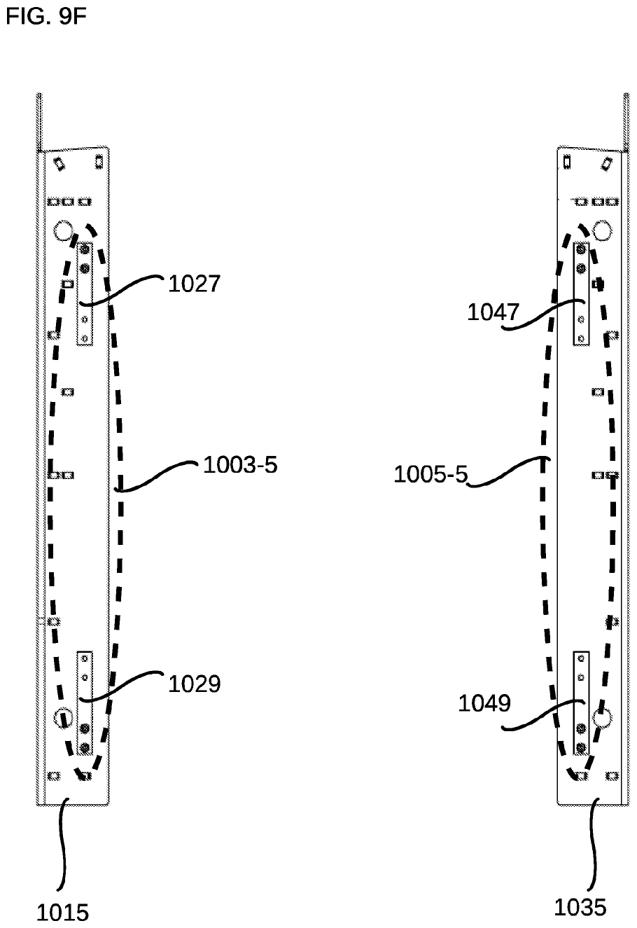

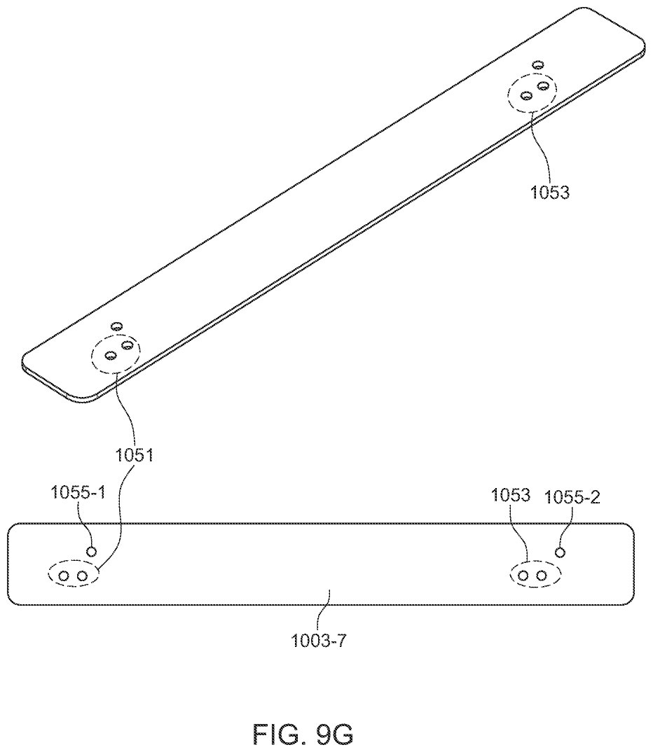

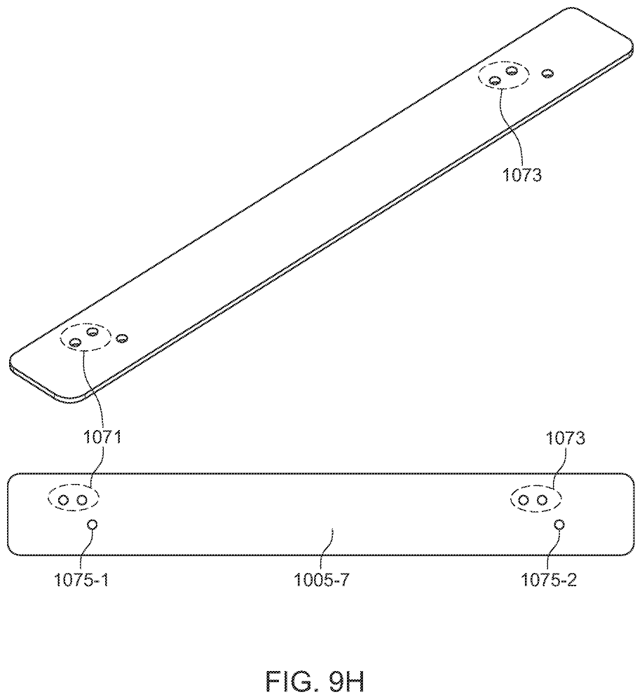

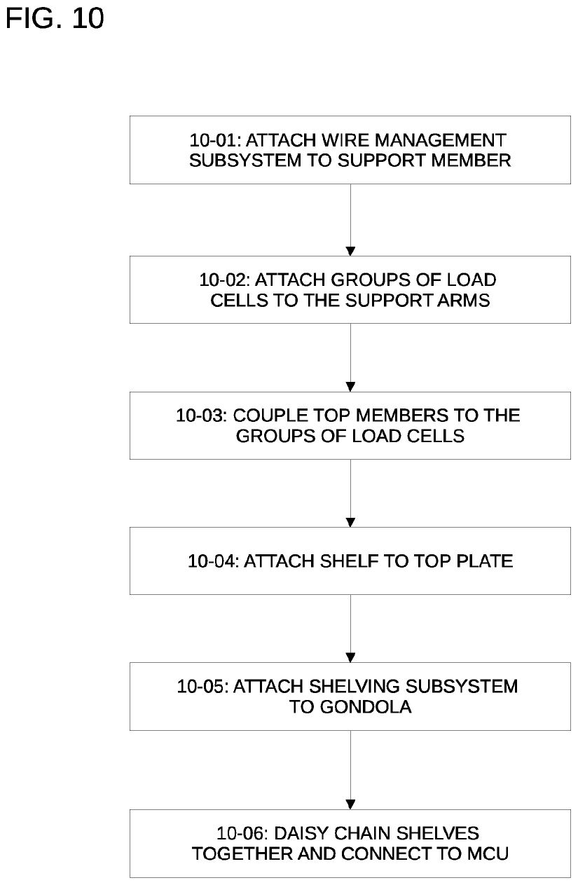

FIGS. 9A to 9H and FIG. 10 demonstrates an exemplary embodiment of a support system to enable an angled shelf and a flowchart to assemble the angled shelf. In the design shown below, the load cells are moved into the support members on either side of the angled shelf. This leaves enough space under the part of the shelf which carries the food items for elements such as heating elements.

In FIG. 9A, support system 1000 comprises two (2) support members 1002 and 1004 for the left and right side of a plate. An exploded view of support members 1002 and 1004 is shown in FIG. 9B.

In FIG. 9B, left support member 1002 comprises support arm 1003-1, wire management subsystem 1003-3, group of load cells 1003-5, and top member such as plate 1003-7. Right support member 1004 comprises support arm 1005-1, wire management subsystem 1005-3, group of load cells 1005-5, and top member such as plate 1005-7. These components will be explained in further detail below. By placing the groups of load cells and the associated electronics in the support arm, elements such as heating elements can be placed under the part of the shelf which carries the food.

A detailed view of left support arm 1003-1 is shown in FIG. 9C. As shown in FIG. 9C, left support arm 1003-1 comprises sections 1023 and 1025. Section 1025 is an attachment section and comprises a vertical planar surface with coupling members 1021, These are, for example, openings to enable insertion of fasteners to couple left support arm 1003-1 to a structure such as gondola 101 of FIG. 1. Section 1023 is an angled support section, comprising top surface 1015 which is oriented at an angle 1017 to a horizontal plane. Angle 1017 is an appropriately selected angle to enable suitable operation of a gravity fed shelf. In some embodiments, angle 1017 is 15 to 20 degrees. Section 1023 also comprises side surface 1019 which is joined to top surface 1015. In the embodiment shown in FIG. 9C, side surface 1019 is a vertical planar surface which is joined to, and coplanar with section 1025. In some embodiments, top surface 1015 is perpendicular to side surface 1019. Load cell coupling members are used to enable coupling of load cells to top surface 1015. Examples of load cell coupling members are groups of openings 1011 and 1013 in FIG. 9C. Suitable fastening members can then be used to enable coupling of load cells.

A detailed view of right support arm 1005-1 is shown in FIG. 9D. Similar to left support arm 1003-1, right support arm 1005-1 comprises sections 1043 and 1045. Section 1045 is an attachment section comprising a vertical planar surface with coupling members 1041. Coupling members 1041 are, for example, openings to enable insertion of fasteners to couple right support arm 1005-1 to a structure such as gondola 101 of FIG. 1. Section 1043 is an angled support section, similar to section 1023. It is oriented at angle 1037 to the horizontal plane. Angle 1037 is the same as angle 1017. Section 1043 also comprises side surface 1039 which is joined to top surface 1035. As with side surface 1019, side surface 1039 is a vertical planar surface which is joined to, and coplanar with section 1045. In some embodiments, top surface 1035 is perpendicular to side surface 1039. Top surface 1035 comprises load cell coupling members in the form of groups of openings 1031 and 1033. When combined with suitable fastening members, the load cell coupling members enable coupling of load cells.

Additionally, each of left and right support members 1003-1 and 1005-1 comprises wire management subsystems with a plurality of securing elements to ensure that the wires leading to the load cells are secured to the support members. An example of a securing element is a clip. Different arrangements of securing elements are possible. An example is shown in FIG. 9E. In FIG. 9E, wire management subsystem 1003-3 comprising securing elements is attached to top surface 1015 of left support arm 1003-1. Similarly, wire management subsystem 1005-3 comprising securing elements in the form of clips is attached to top surface 1035 of right support arm 1005-1.

FIG. 9F shows groups of load cells 1003-5 and 1005-5 are attached to left support arm 1003-1 and right support arm 1005-1 respectively. Group 1003-5 comprises load cells 1027 and 1029, while group 1005-5 comprises load cells 1047 and 1049. These groups also comprise the wires which lead to the load cells.

FIGS. 9G and 9H show embodiments of left top member 1003-7 and right top member 1005-7 respectively. In FIG. 9G, left top member 1003-7 comprises load cell coupling members 1051 and 1053 in the form of groups of openings. Then, fastening members can be attached to these openings to ensure that the corresponding group of load cells 1003-5 can be coupled to the left top member 1003-7. Then, group of load cells 1003-5 is coupled to top member 1003-7 from the top, and left support arm 1003-1 at the bottom using load cell coupling members comprising the groups of cells 1011 and 1013, similar to as shown in FIG. 7A. Left top member 1003-7 comprises shelf surface coupling members in the form of openings 1055-1 and 1055-2, to enable coupling of a shelf surface to left top member 1003-7.

Similarly, in FIG. 9H, load cell coupling members 1071 and 1073 in the form of groups of openings allow for fastening members to be attached, and ensure coupling of group of load cells 1005-5 to top member 1005-7 from the top, and right support arm 1005-1 at the bottom. Right top member 1005-7 comprises shelf surface coupling members in the form of openings 1075-1 and 1075-2, to enable coupling of a shelf surface to right top member 1005-7, via insertion of appropriate fasteners such as screws.

In some embodiments, the wires from the load cells are coupled to a shelf electronic unit located in an ambient zone which is at an ambient temperature and where there is no heating. Then, the shelf electronic unit is electrically and communicatively coupled to a shelf controller such as shelf controller 105, and operates as described above. In some embodiments, the shelf electronic unit comprises components similar to pre-processing board 817 and PCB 827 of FIG. 8A.

FIG. 10 shows an example flowchart for assembly of an angled shelf. In step 10-01, a wire management subsystem such as subsystem 1003-3 or 1005-3 is attached to a support member, such as support member 1003-1 or 1005-1. As explained above and with reference to FIG. 9E, this is performed by attaching the wire management subsystems 1003-3 or 1005-3 to top surface 1015 of left support arm 1003-1, and top surface 1035 of right support arm 1005-1. The attaching is performed by, for example, using heat resistant glue.

In step 10-02, groups of load cells 1003-3 and 1005-3 are coupled to support members 1003-1 and 1005-1. As explained above and in FIG. 9C, load cell coupling members in the form of groups of openings 1011 and 1013 are used to enable the coupling of the groups of load cells 1003-3 and 1005-3 to top surfaces 1015 and 1035 of support members 1003-1 and 1005-1 respectively. Fastening members such as appropriately-sized screws or other appropriate fastening members are used to couple the load cells to the top surfaces. The wires are attached to the groups of load cells and secured to the support members 1003-1 and 1005-1 using the securing elements in the wire management subsystems 1003-3 and 1005-3, as explained above.

In step 10-03, the top members 1003-7 and 1005-7 are coupled to the groups of load cells 1003-3 and 1005-3 respectively. Top member 1003-7 is coupled to group of load cells 1003-3 using load cell coupling members comprising groups of openings 1051 and 1053. Suitable fasteners such as screws are used to attach the top members to the group of load cells 1003-3 to top member 1003-7. Similarly, top member 1005-7 is coupled to group of load cells 1005-3 using load cell coupling members comprising groups of openings 1071 and 1073.

In step 10-04 the assembled support members are coupled to a gondola using, for example, coupling members 1021 and 1041. This comprises, for example, inserting fasteners into coupling members 1021 and 1041 to complete the coupling to the gondola.

In step 10-05, a shelving surface is coupled to the top members by, for example, inserting appropriate fasteners into openings 1055-1, 1055-2, 1075-1 and 1075-2 and attaching the shelving surface.

In step 10-06, the shelves are daisy-chained together using CAT-5e or CAT-6 cables, and connected to an shelf controller such as shelf controller 105.

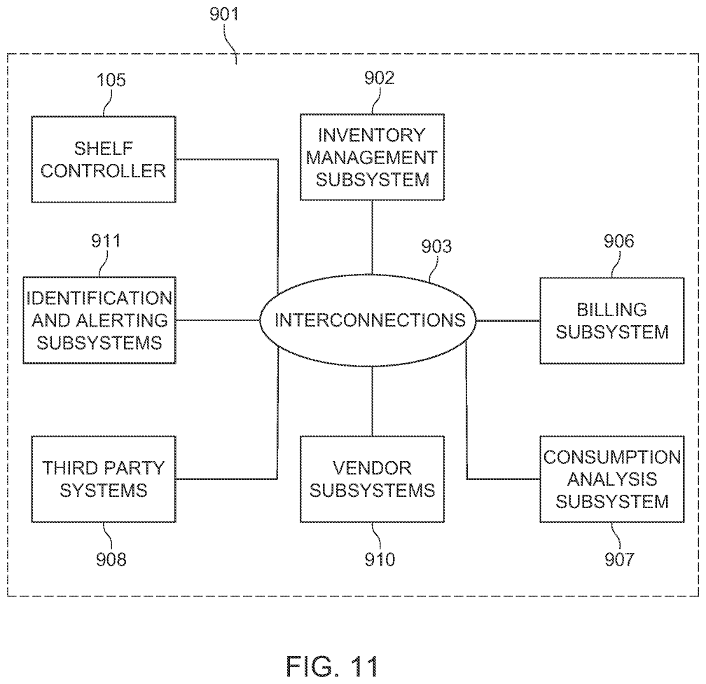

In some embodiments, the shelf controller 105 is coupled to a system comprising one or more subsystems to assist in the management of the retail outlet. Referring to FIG. 11, an example management system 901 is illustrated.

Interconnections 903 enable the components of system 901 to communicate as needed. This comprises communicatively coupling the various components of system 901 with each other, and also with destinations outside of system 901 as needed. Interconnections 903 may be implemented in a variety of ways. For example, in some embodiments, interconnections 903 comprise one or more networks. In some of these embodiments, one or more of these one or more networks comprise one or more subnetworks. The one or more networks comprise, for example, wireless networks, wired networks, Ethernet networks, local area networks, metropolitan area networks and optical networks. In some embodiments, the one or more networks comprise at least one of a private network such as a virtual private network, or a public network such as the Internet. In some embodiments, interconnections 903 also comprise one or more direct connections between the components of system 901. Various wired or wireless communications protocols known to those of skill in the art may be used to implement interconnections 903. These include, for example, POE, PoE+, near field communications (NFC), Wi-Fi, BLUETOOTH®, Radio Frequency Identification (RFID), 3G, Long Term Evolution (LTE), 5G and Universal Serial Bus (USB). In some embodiments, interconnections 903 comprises components such as switches, for example, backroom switch 809 of FIG. 8B; routers and bridges. In some embodiments, in addition to communicative coupling, interconnections 903 also provide power to components of system 901 such as shelf controller 105.

Billing subsystem 906 operates to assist the retailer with the management of customer billing and invoicing. Billing subsystem 906 stores, for example, pricing data for each SKU ID to enable calculation of customer bills and invoices. Billing subsystem 906 performs functions such as generation of customer bills or invoices, collections of payments from customers which includes, for example, receiving debit and credit card payments. In some embodiments, billing subsystem 906 is implemented using software. In other embodiments, billing subsystem 906 is implemented using a combination of hardware and software. Billing subsystem 906 is coupled to the other components of system 901 via interconnections 903.

Inventory management subsystem 902 operates to assist the retailer with management of stock or inventory held by the retail outlet. Examples of functions performed by inventory management subsystem 902 include, for example,
recording current amounts of inventory;
determining remaining stock of, for example, the one or more items located on the shelves throughout the retail outlet;
determining threshold levels of inventory needed for the retail outlet to function for a given period of time based on, for example, historical consumption patterns;
determining time to exhaustion of inventory based on, for example, determination of remaining stock/inventory and historical consumption data; and
determining whether there is a need to transmit requests for orders of items based on the determination of the remaining stock.

In some embodiments, these functions are performed in conjunction with one or more components of system 901. For example, in some embodiments inventory management subsystem 902 works together with consumption analysis subsystem 907 to determine remaining stock, threshold levels or whether there is a need to transmit requests for orders of one or more items sold by the retailer. In some embodiments, these functions are performed using predictive analytics. In some embodiments, these functions are performed using artificial intelligence (AI) or machine learning (ML) techniques.

In some embodiments, inventory management subsystem 902 is implemented using software. In other embodiments, inventory management subsystem 902 is implemented using a combination of hardware and software. Inventory management subsystem 902 is communicatively coupled to the other components of system 901 via interconnections 903.

Consumption analysis subsystem 907 determines, calculates and records past, current and future consumption of the one or more items within the retail outlet based on data received from, for example, shelf controller 105. This includes, for example, storing information for use in calculations. This information comprises, for example:
Weight measurement data received from the shelf controller;
Device identifiers corresponding to each of the gondolas and shelves;
SKU identifiers (IDs) corresponding to the items;
Consumption data calculated based on the received weight measurement data;
Nutritional data;
One or more calculation data related to one or more items sold within the retail outlet comprising at least one of:
   Revenue data, comprising, for example, prices per unit of an item;
   Cost data, comprising, for example, supplier cost per unit of an item;
   Shelf identification data, to enable identification of SKU IDs when these items are taken from shelves. In some embodiments, this may comprise shelf location data within the store;
   Weights corresponding to item SKU IDs;
   Inventory data; and
   Temperature and humidity data related to temperature and humidity of one or more parts of the retail outlet, for example, temperatures and humidities of various areas of the retail outlets, fridges and ovens.

Examples of operations performed by consumption analysis subsystem 907 include but are not limited to:
Determination of amounts of items taken based on, for example, measurement data received from shelf controller 105 and correlation with SKU IDs;
Calculation of consumption data based on measurement data received from shelf controller 105;
Determination of at least one of remaining stock of an item based on the received measurement data and stored calculation data;
Determination of time to exhaustion of an item based on determination of remaining stock of the item and historical consumption data; and
Determination of occurrence of fraud events based on analysis of billing data received from billing subsystem 906;

In some embodiments, these operations are performed by processing subsystems consumption analysis subsystem 907 in conjunction with one or more other components of system 901. For example, in some embodiments, consumption analysis subsystem 907 works together with inventory management subsystem 902 to determine the remaining stock of an item. In some embodiments, this determination of remaining stock is then used to determine a time to exhaustion of the item based on historical consumption data. In other embodiments, consumption analysis subsystem 907 works together with billing subsystem 906 to determine the cost of items taken by a customer, and calculate a bill or an invoice.

In other embodiments, consumption analysis subsystem 907 receives billing data from billing subsystem 906 via interconnections 903 and determines the occurrence of fraud events based on comparison of the received billing data and the determined generated revenue.

Some retailers have retail outlets at a plurality of locations, and therefore have a need for monitoring and management over the plurality of locations. In some embodiments, a plurality of systems such as system 901 is implemented at each location, and data is transmitted from each location to a back-office system. Then data such as:
Brand, location and product performance across the plurality of locations;
Levels of inventory across the plurality of locations;
Staff performance across the plurality of locations;
Top selling products across the plurality of locations;
Top performing locations;
Worst selling products; and
Worst performing locations;
   is collected and analyzed so as to provide vital information and improve profitability. In some embodiments, the back-office system is comprised of a cluster of globally distributed remote servers, all interconnected to work together to increase performance, reliability, scalability and accessibility.

Returning to FIG. 11, identification and alerting subsystems 911 comprise, for example, the previously described video capture subsystems which work together with, for example shelf controller 105 and other subsystems to identify customers for billing. Identification and alerting subsystems 911 also comprise alert processing and notification subsystems to process received alert signals and send notifications to management to enable action to be taken. For example, in some embodiments, the alerts due to open doors are transmitted by shelf controller 105 to these alert processing and notification subsystems so as to enable action to be taken by the management of the retailer.

Vendor subsystems 910 are subsystems owned by the vendors of the one or more items carried by the retail outlets. Other components of system 901 send orders or requests to these vendor subsystems using interconnections 903.

Third party subsystems 908 are subsystems provided by organizations other than vendors outside of the retail outlet. Examples include:
Subsystems owned by, for example, payment processor organizations or financial institutions; and
Subsystems provided by Government regulatory bodies.

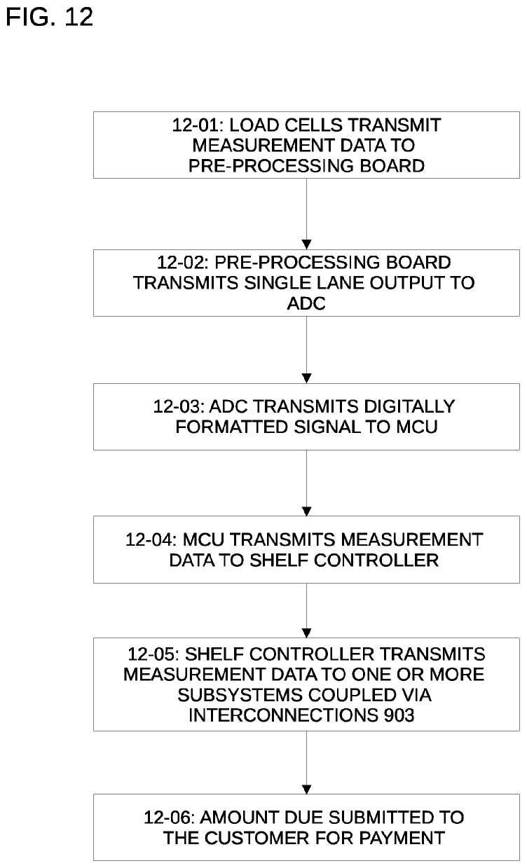

FIG. 12 shows an example embodiment of a flow when a customer takes an item from a shelf. In steps 12-01 to 12-04, after the customer takes the item from the shelf, the smart shelving subsystem transmits the new weight measurement to the shelf controller 105. In some embodiments, this comprises the following steps:

In step 12-01, one or more load cells in a lane transmit the new measurement to the pre-processing board. For example, load cells 341-1 and 341-2 transmit the new measurement to pre-processing board 817.

In step 12-02, the pre-processing board 817 accepting the inputs from the load cells, processing the inputs into a single lane output and transmitting the single lane output to an input such as one of the inputs 819 of multichannel ADC 825.

In step 12-03, the ADC 825 receives the analog-formatted single lane output, converting the received signal into a digitally formatted signal and transmits the digitally formatted signal to MCU 821.

In step 12-04, MCU 821 generates and transmits signals comprising the measurement data to shelf controller 105. As explained previously, in some embodiments, this comprises the MCU combining the digitally formatted signal with a time stamp received from shelf controller 105. As explained previously, the MCU 821 formats the generated signal for transmission using the CAN bus extended frame format. The MCU 821 then transmits the CAN-formatted generated signals to shelf controller 105.

In step 12-05, the shelf controller 105 receives the signals comprising the measurement data. Based on these received signals, the shelf controller 105 transmits a signal comprising the measurement data to one or more of the subsystems coupled via interconnections 903, so as to determine the amount of items taken and ensure the customer is billed appropriately. For example, in some embodiments, shelf controller 105 transmits the signal to consumption analysis subsystem 907, which then interacts with, for example, billing subsystem 906 and identification and alerting subsystem 911 in ways explained above to determine:
the amount of items taken,
the price of the items taken,
the customer who has taken the items, and
the cost which must be billed to the identified customer.

In step 12-06, once the total amount due is determined for the customer, then amount is submitted to the customer for payment. This comprises, for example, billing subsystem 906 sending an invoice to a customer account using interconnections 903 for payment via, for example, a credit card or other methods of payment. In some embodiments, payment is automatically made using, for example third party subsystems 908.

As explained previously, step 8C-06 of FIG. 8C comprises further configuration after a shelf is assembled. In some embodiments, this further configuration comprises configuring one or more subsystems of system 901 such as consumption analysis subsystem 907, billing subsystem 906, inventory management subsystem 902 and identification and alerting subsystem 911 to ensure accurate billing and invoicing when items are taken from lanes by customers.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

1-22. (canceled)

23. A shelf comprising a sensing assembly and a base assembly, further wherein:
the sensing assembly comprises a plurality of lanes,
each of the plurality of lanes comprising at least one sensing plate coupled to a plurality of load cells,
the plurality of load cells coupled to the at least one sensing plate and the base assembly, and
the plurality of load cells located within a measurement section; and
a shelf controller is electrically and communicatively coupled to the shelf using a power over Ethernet (POE) protocol, further wherein
the shelf controller supplies an amount of power to the shelf using three pairs of wires in a CAT-5e or CAT-6 cable.

24. The shelf of claim 23, wherein a location of the measurement section is based on a flexing of the at least one sensing plate.

25. The shelf of claim 24, wherein the at least one sensing plate comprises one or more airflow openings.

26. The shelf of claim 23, wherein each of the plurality of lanes is bounded by two lane partition members.

27. The shelf of claim 26, wherein a width of the lane is adjusted based on the placement of the lane partition members.

28. The shelf of claim 23, wherein the amount of power supplied to the shelf is less than or equal to a regulatory limit.

29. The shelf of claim 28, wherein an installation cost is reduced due to the supplied amount of power being less than or equal to the regulatory limit.

30. The shelf of claim 23, wherein the shelf controller is communicatively coupled to one or more reed switches in one or more refrigerators or freezers, and
when a door of the one or more refrigerators or freezers is left open, one of the one or more reed switches sends a signal to the shelf controller.

31. The shelf of claim 23, wherein the shelf controller is electrically and communicatively coupled to a different shelf.

32. The shelf of claim 23, wherein the shelf comprises a temperature sensor and a humidity sensor.

33. A shelf comprising a sensing assembly and a base assembly, further wherein:
the sensing assembly comprises a plurality of lanes,
each of the plurality of lanes comprising at least one sensing plate coupled to a plurality of load cells,
the plurality of load cells coupled to the at least one sensing plate and the base assembly, and
the plurality of load cells located within a measurement section; and
a shelf controller is electrically and communicatively coupled to the shelf using a power over Ethernet (POE) protocol, further wherein
the shelf communicates data to the shelf controller using a Collector Area Network extended frame format, and
the shelf controller supplies an amount of power to the shelf using three pairs of wires in a CAT-5e or CAT-6 cable.

34. The shelf of claim 33, wherein a location of the measurement section is based on a flexing of the at least one sensing plate.

35. The shelf of claim 34, wherein the at least one sensing plate comprises one or more airflow openings.

36. The shelf of claim 33, wherein each of the plurality of lanes is bounded by two lane partition members.

37. The shelf of claim 36, wherein a width of the lane is adjusted based on the placement of the lane partition members.

38. The shelf of claim 33, wherein the amount of power supplied to the shelf is less than or equal to a regulatory limit.

39. The shelf of claim 38, wherein an installation cost is reduced due to the supplied amount of power being less than or equal to the regulatory limit.

40. The shelf of claim 33, wherein the shelf controller is communicatively coupled to one or more reed switches in one or more refrigerators or freezers, and
when a door of the one or more refrigerators or freezers is left open, one of the one or more reed switches sends a signal to the shelf controller.

41. The shelf of claim 33, wherein the shelf controller is electrically and communicatively coupled to a different shelf.

42. The shelf of claim 33, wherein the shelf comprises a temperature sensor and a humidity sensor.
